(19) United States
(12) Patent Application Publication
(10) Pub. No.: US 2026/0230911 A1
(43) Pub. Date: Aug. 6, 2026

(54) METHODS AND APPRATUS FOR HANDLING DEPENDENCIES FOR XR TRAFFIC IN WIRELESS SYSTEMS BASED ON CONFIGURATION OF LCH RESTRICTED TO HANDLE DEPENDENCIES

(71) Applicant: InterDigital Patent Holdings, Inc., Wilmington, DE (US)

(72) Inventors: Tejaswinee Lutchoomun, Montreal (CA); Jaya Rao, Montreal (CA); Michael Starsinic, Newtown, PA (US)

(73) Assignee: InterDigital Patent Holdings, Inc., Wilmington, DE (US)

(21) Appl. No.: 19/151,496

(22) PCT Filed: Feb. 12, 2024
(86) PCT No.: PCT/US2024/015437

§ 371 Date: Jul. 28, 2025

Related U.S. Application Data
(60) Provisional application No. 63/445,505, filed on Feb. 14, 2023.

(51) Int. Cl. H04W 28/02

(52) U.S. Cl. CPC H04W 28/0268

(57) ABSTRACT

A wireless transmit/receive unit (WTRU) may receive, from a network (NW) entity, configuration information for one or more logical channels (LCHs), some of which may be restricted to handle dependency between protocol data units (PDUs). The WTRU may receive sets and determine dependency requirements for the sets of PDUs based on information associated with the sets of PDUs. The WTRU may determine a priority associated with LCHs and determine the LCHs meeting the dependency requirements for the sets of PDUs for mapping the sets of PDUs to the LCHs.

### CROSS-REFERENCE TO RELATED APPLICATIONS

This application claims the benefit of U.S. Provisional Patent Application No. 63/445,505 filed on Feb. 14, 2023, the entire contents of which are incorporated herein by reference.

### BACKGROUND

The term extended Reality (XR) is an umbrella term for different types of immersive experiences including Virtual Reality (VR), Augmented Reality (AR) and Mixed Reality (MR) and the realities interpolated among them. Virtual Reality (VR) is a rendered version of a delivered visual and audio scene. The rendering is designed to mimic the visual (e.g. stereoscopic 3D) and audio sensory stimuli of the real world as naturally as possible to an observer or user as they move within the limits defined by the application. Augmented Reality (AR) is when a user is provided with additional information or artificially generated objects/items or content overlaid upon their current environment. Mixed Reality (MR) is an advanced form of AR where some virtual elements are inserted into the physical scene with the intent to provide the illusion that these elements are part of the real scene. XR may include to all real-and-virtual combined environments and human-machine interactions generated by computer technology and wearables.

The notion of immersion in the context of XR applications/services refers to the sense of being surrounded by the virtual environment as well as providing the feeling of being physically and spatially located in the virtual environment. The levels of virtuality may range from partial sensory inputs to fully immersive multi-sensory inputs leading to a virtual reality practically indiscernible from actual reality.

In this disclosure, a wireless transmit/receive unit (WTRU) may correspond to any XR device/node which may come in variety of form factors. The typical WTRU (e.g. XR WTRU) may include, but not limited to the following: Head mounted displays (HMD), optical see-through glasses and camera see-through HMDs for AR and MR, mobile devices with positional tracking and camera, wearables, haptic gloves, haptic body suit, haptic shoes, etc. In addition to the above, several different types of XR WTRU may be envisioned based on XR device functions for e.g. as display, camera, sensors, sensor processing, wireless connectivity, XR/Media processing and power supply, to be provided by one or more devices, wearables, actuators, controllers and/or accessories. One or more device/nodes/WTRUs may be grouped into a collaborative XR group for supporting any of XR applications/experience/services.

In XR services and applications, the traffic may consist of data or a protocol data unit (PDU) which may be associated with an application data Unit (ADU), PDU Set or data burst. In an example, the one or more PDUs belonging to a PDU Set may be associated with different segments or components of a video frame or a video slice. A data burst may consist of one or more PDU Sets. For example, a number of PDUs in an PDU Set or data burst of a total payload size (e.g. units of bits/bytes) transmitted in the uplink (UL) and/or received in the downlink (DL) may be dependent on the type of the media frame (e.g. 3D video frame, audio frame).

### SUMMARY

In embodiments, a wireless transmit/receive unit (WTRU) may include a processor configured to receive, from a network (NW) entity, configuration information for a first one or more logical channels (LCHs) and a second one or more LCHs, the second one or more LCHs including one or more LCHs that are restricted to handle dependency between protocol data units (PDUs). The WTRU may receive, from an extended reality (XR) application, a first set of PDUs and a second set of PDUs. The WTRU may further determine dependency requirements for the first set of PDUs and the second set of PDUs based on information associated with the first set of PDUs and the second set of PDUs. Moreover, the WTRU may determine a first priority associated with the first one or more LCHs and a second priority associated with the second one or more LCHs. The WTRU may also in response to the second priority of the second one or more LCHs meeting the dependency requirements for the first set of PDUs and the second set of PDUs, map the first set of PDUs and the second set of PDUs to the second one or more LCHs.

The WTRU may in response to a conflict between the priority of the first one or more LCHs and the second one or more LCHs, map the first set of PDUs and the second set of PDUs to the second one or more LCHs.

The dependency requirements may be based on arrival times or a data type.

The WTRU may determine to prioritize the second one or more LCHs over the first one or more LCHs based on upon determining that the first priority of the first one or more LCHs equals to the second priority of the second one or more LCHs.

The WTRU may also receive, from the network entity, configuration information for a third one or more LCHs.

In an embodiment, the WTRU may in response to the second priority of the second one or more LCHs does not meet the dependency requirements for the first set of PDUs and the second set of PDUs, map the first set of PDUs and the second set of PDUs to the third one or more LCHs. A third priority of the third one or more LCHs may meet the dependency requirement for the first set of PDUs and the second set of PDUs.

In another embodiment, the WTRU may in response to the second priority of the second one or more LCHs does not meet the dependency requirements for the first set of PDUs and the second set of PDUs, send, to the network entity, an indication to request for a third one or more LCHs. A third priority of the third one or more LCHs may meet the dependency requirement for the first set of PDUs and the second set of PDUs.

In one example, the WTRU may in response to determining that the third one or more LCHs are not received, further map the first set of PDUs to the first one or more LCHs.

In another example, the WTRU may receive, from the network entity, a range of allowable changes to the configuration information, and adjust the configuration information to accommodate the dependency between the first set of PDUs and the second set of PDUs.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of the scheduling inefficiencies resulting from dependencies not being met for various PDU Sets.

FIG. 3 shows an example of the flow of two PDU Sets, with the PDU Set delay budgets (PSDB) mapped to a corresponding quality of service (QoS) flow and then to a data radio bearer (DRB).

FIG. 4A shows an example of DRB selection/dynamic change to meet QoS requirements.

FIG. 4B shows another example of DRB selection/dynamic change to meet QoS requirements.

FIG. 5A shows an example of a network configuration of a logical channel (LCH) that is restricted to handle dependencies.

FIG. 5B shows another example of a network configuration of a logical channel (LCH) that is restricted to handle dependencies.

### DETAILED DESCRIPTION

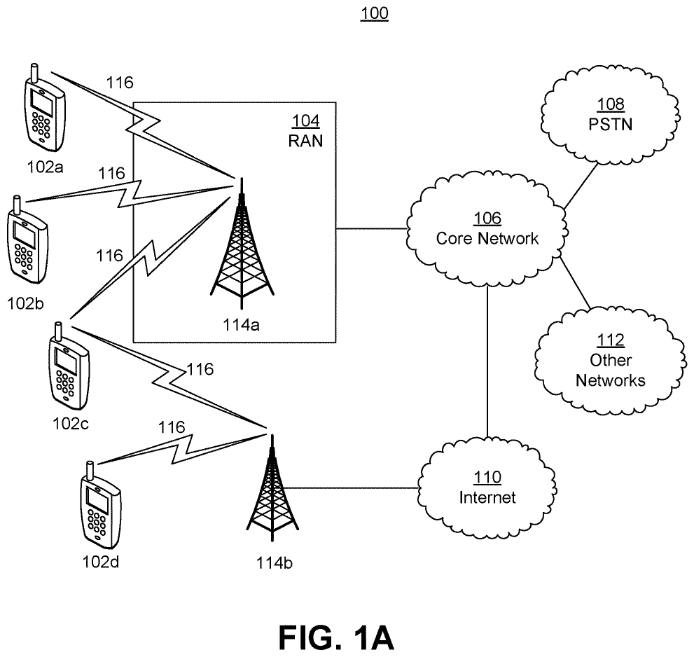

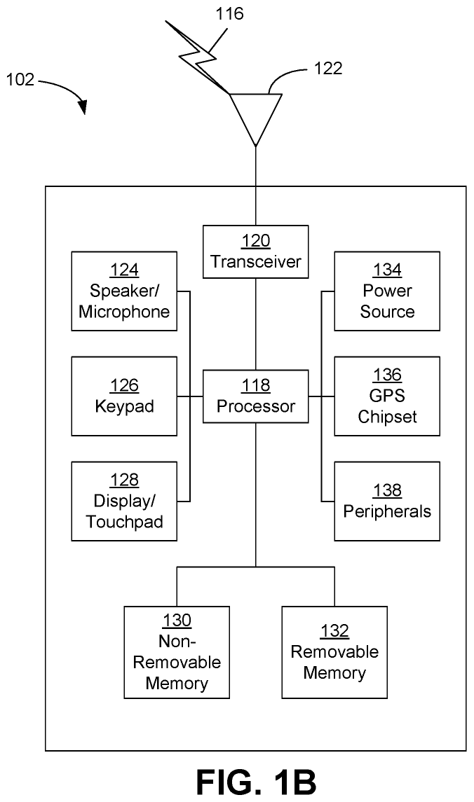

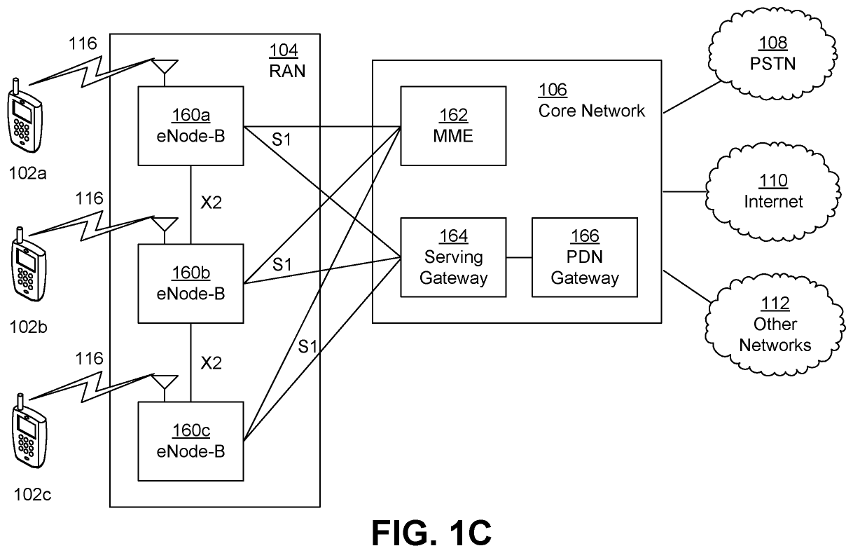

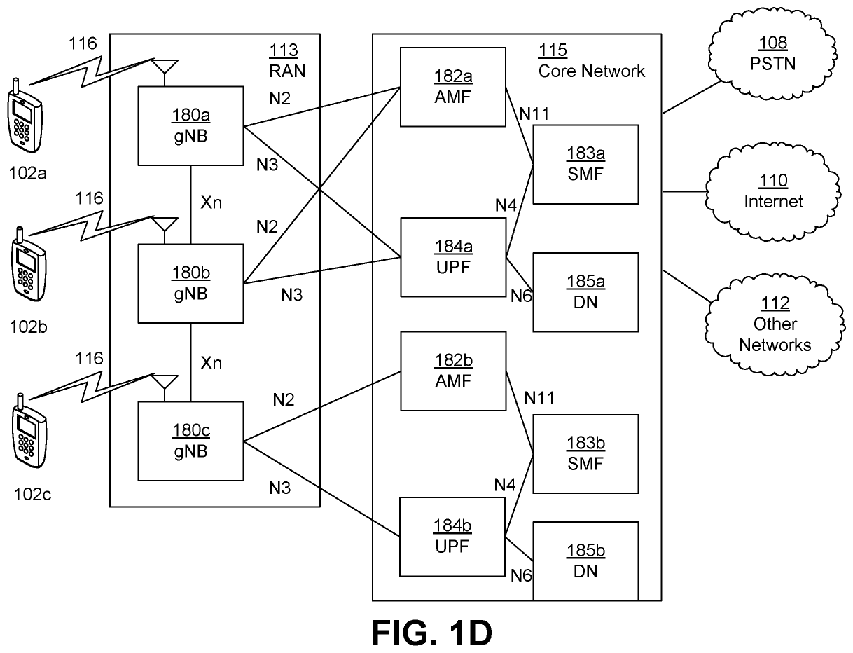

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of the WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (e.g., WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNodeB (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUS 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

One or more of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of one or more of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of one or more of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the medium access control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: the WTRU 102a-d, the Base Station 114a-b, the eNode-B 160a-c, the MME 162, the SGW 164, the PGW 166, gNB 180a-c, the AMF 182a-ab, the UPF 184a-b, the SMF 183a-b, the DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or the WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In XR traffic, dependencies may exist between PDUs (within PDU Sets or data bursts), between PDU Sets, between data bursts, and/or across multiple flows. A dependency between PDUs may be defined by data type, transmission/arrival time, and/or other dependency parameters. For example, the PDUs may include multimedia data, such as video data and/or audio data. The multimedia data may include different data types that may be dependent on one another. In one example, when the PDUs or PDU sets include intra-coded picture frames (I-frames), predicted picture frames (P-frames), and/or bidirectional predicted picture frames (B-frames), the P-frames and/or B-frames may be dependent on one or more I-frames. The I-frames may include an entire image and may be encoded without reference to other frames. The P-frames and/or B-frames may include image and/or video data and may reference other frames, such as I-frames or other P-frames/B-frames. As such, the P-frames and/or B-frames may be dependent on other frame types. There may also be dependencies between any two frames or type thereof.

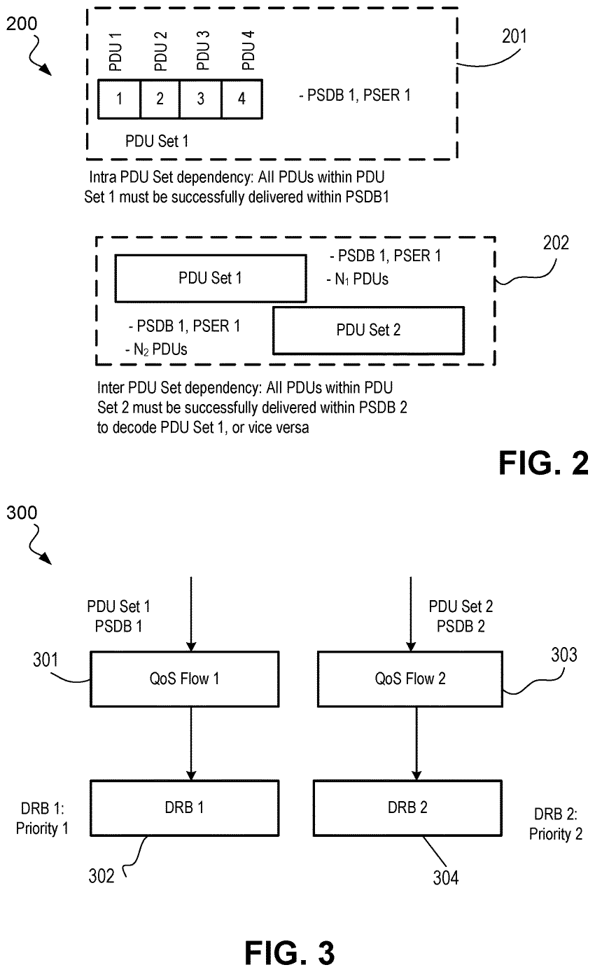

FIG. 2 in the process 200, shows an example of the scheduling inefficiencies resulting from dependencies not being met for various PDU Sets. As used herein, at 201, dependencies between PDUs (e.g., PDUs 1-4) of a PDU Set may be referred to as Intra-PDU Set dependencies. For Intra PDU Set dependency, each PDU within PDU Set 1 may be successfully delivered within a PDU Set delay budgets (PSDB), such as PSDB 1. PDU Set Delay Budget (PSDB), as defined in Release 18 XR (TR 23.700-60) may be the time between reception of the first PDU (at the UPF in DL, at the UE in UL) and the successful delivery of the last arrived PDU of a PDU Set (at the UE in DL, at the UPF in UL). Further, at 202, dependencies between one or more PDU Sets may be referred to as Inter-PDU Set dependencies. For Inter PDU Set Dependency, each PDU within PDU Set 2 may be successfully delivered within PSDB 2 to decode PDU Set 1, or vice versa.

PDU-sets may be implemented for the handling and delivery of a group of PDUs belonging to one PDU-set as being composed of one or more PDUs carrying the payload of one unit of information generated at the application level (e.g., a frame or video slice for XRM Services). In some implementations PDUs in a PDU Set may be needed by the application layer to use the corresponding unit of information. In other implementations, the application layer may still recover parts of the information unit, when some PDUs are missing.

There may be multiple types of PDU Sets for different types of applications and/or data types e.g., video data, audio data, etc.). A first type of PDU Set (e.g., Type I) may not tolerate any loss/delay for any PDU of the PDU Set or a loss/delay above a predefined threshold. When a loss or delay is above a threshold (e.g., loss or delay one of the PDUs above a period of time), the rest of the PDUs may be dropped. A second type of PDU Set (e.g., Type II) may tolerate some loss/delay or a loss/delay above the predefined threshold. XR application may reconstruct the PDU Set with delay/loss of some PDUs of PDU Set, depending on the types of applications and/or data types.

PDU Set integrated indication (PSII) or PDU Set Integrated Handling Indication (PSIHI) may be implemented for handling PDUs in different types of PDU sets depending on certain parameters. A PDU set mapped to a QoS flow with the PSII or PSIHI indicator may be a type of type where each of the PDUs of the PDU set are implemented for the successful decoding of the PDU set at the application. PDU sets may have a PSII or PSIHI indicator. Or other constructs to which PDU sets are mapped (e.g., QoS flow, DRB, LCH, etc.) may have a PSII or PSIHI indicator. The absence of such an indicator may indicate a non-PSII or non-PSIHI PDU set, e.g., a PDU set which may be decoded at the application even if one or more PDUs of the PDU set are lost and/or delayed beyond the PSDB. For example, the PDU Set QoS parameters may be defined to support PDU Set handling for different types of PDU Sets. A device, and/or application executing thereon, may use the PDU Set QoS parameters to determine whether or not each of the PDUs in a PDU Set are needed for the usage of PDU Set by the application layer (PDU Set Integrated Indication) (e.g., to meet a certain quality threshold of service).

Dependencies not being met (e.g., by successful reception and/or decoding of dependent PDUs/PDU Sets within certain timeframes) may result in scheduling inefficiencies. For example, unsuccessful transmission/reception of one PDU Set may render other successfully delivered PDU Sets useless, since the application executing on a device cannot decode the dependent PDU Sets.

Embodiments are described herein to handle dependencies in XR traffic. Examples are described for handling dependencies in XR traffic during one or more of the selection of data radio bearers (DRBs) and/or LCHs.

In an example, LCP procedures may support prioritization based on LCH parameters (e.g., priority, prioritized bit rate (PBR), buffer size duration (BSD), and/or other LCH parameters).

In some procedures for DRB and LCH selection/mapping, an LCP procedure may handle packets on a per-PDU basis. They may not be adapted to handling packets on a PDU Set-basis. Further, they may not be adapted to handle any dependencies that may exist between PDUs of a PDU Set or between multiple PDU Sets. In XR, dependencies being violated may result in higher PDU Set error rate (PSER) and scheduling inefficiencies.

In an example, an unsuccessful transmission/reception of one PDU Set may render other successfully delivered PDU Sets useless, since the application executing on a device cannot decode the dependent PDU Sets. Based on these issues, procedures may be implemented to consider dependencies in XR traffic when managing dependent PDUs/PDU Sets, as described herein.

One example for managing dependent PDUs/PDU Sets may include managing the multiplexing of PDUs/PDU Sets. One embodiment for multiplexing may involve DBR selection/dynamic change to meet QoS requirements. The WTRU may receive a configuration of sets of DRBs from a network entity. For example. the WTRU may receive from the network (NW), e.g., in radio resource control (RRC), a set of DRBs configured by the gNB and/or their indicated priority (e.g., DRB1, priority of DRB1, DRB2, priority of DRB2). One or more DRBs may be configured (e.g., by the network) for and/or reserved for dependent PDUs/PDU Sets. The WTRU may receive PDU Set 1 and its associated priority (e.g., importance), e.g., from XR application. The WTRU may map the PDU Sets to DRBs based on the associated priority. For example, the WTRU may map/forward PDU Set 1 to DRB1 based on priority of PDU Set 1. The WTRU may receive PDU Set 2 and its associated priority, e.g., from XR application (e.g., PDU Set 2 may arrive later than expected). The WTRU may determine information on dependency based on, e.g., arrival times, data type, and/or other dependency parameters. For example, the WTRU may determine, based on the dependency parameters, that PDU Set 1 and PDU Set 2 are dependent. The WTRU may further determine success rate of PDU Set 1 based on feedback and/or remaining delay. The determination methods for performance/success rate of a set of PDUs may be statistical or instantaneous. The WTRU may determine the QoS/priority of PDU Set 2 based on performance/success rate of first PDU Set. For example, the WTRU may keep track of the performance/success rate of a PDU Set based on its performance over a past time window and take these statistics into account when determining to switch the mapping of another PDU Set to the DRB of that PDU Set. As a further example, the WTRU may do spot checks on the performance/success rate of a PDU Set instantaneously. For example, the WTRU may determine to change priority of PDU Set 2 to ensure QoS and dependencies by either mapping of PDU Set 2 to DRB 1 (if performance/success rate of DRB1 is greater than a configured threshold) or mapping of PDU Set 2 to another preconfigured DRB 3 (priority of DRB 3 is greater than priority of DRB 2).

A further embodiment for multiplexing may involve configuration of the LCH to be restricted to handle dependencies, which may be considered a network assisted embodiment. The WTRU may receive a configuration of sets of LCHs from a network entity. For example, the WTRU may receive from the NW, e.g., in RRC, a set of LCHs configured by the gNB. One or more LCH may be restricted to handle dependency (e.g., LCH B). The WTRU may receive one or more PDU Sets, e.g., from XR application. The WTRU may determine information on dependency based on e.g., arrival times, data type, and/or other dependency parameters. For example, the WTRU may determine that PDU Set 1 and PDU Set 3 are dependent based on the dependency parameters. If parameters of LCH B (e.g., priority, PBR) meet the requirements for dependent PDU Sets (PDU Set delay budgets (PSDB), e.g., PSDB1, PSDB3), the WTRU may map dependent PDU Sets to LCH B. In case of conflict between independent LCH and restricted dependent LCH during LCP procedure, the WTRU may be configured to prioritize restricted dependent LCH, which may result in a reduction of the impact to the PSER. As an example, if priority of LCH A (a non-dependent LCH that may consider parameters such as priority) is the same as priority of LCH B (a special LCH configured and/or reserved for handling dependencies), the WTRU may be configured to prioritize LCH B.

In embodiments, multiplexing may involve the selection of PDUs for filling Medium Access Control (MAC) PDU/Transport Block to consider dependencies in addition to QoS, which may be considered a MAC embodiment. The configuration parameters that are received for from a network entity for configuration of LCHs may include a time threshold (T). For example, the WTRU may receive from the NW, e.g., in RRC, a set of LCHs configured by the gNB and time threshold T. The WTRU may receive, from XR application, PDUs from one or more PDU Sets (e.g., PDU 1 of PDU Set 1, PDUs 1, 2 of PDU Set 3).

In Within the discussion herein, the term network (NW) may include one or more of a base station (e.g., gNB, transmission/reception point (TRP), RAN node, access node), core network function (e.g. AMF, SMF, policy control function (PCF), Network Exposure Function (NEF)) and application function (e.g. edge server function, remote server function), for example. Further, flows may correspond to one or both of QoS flows or data flows. For example. The flow of data consisting of one or more PDUs, PDU Sets or data bursts, may be associated with one or more QoS requirements, e.g., latency, data rate, reliability, Round Trip Time (RTT) latency). Different flows, possibly originating from a common application/experience source and/or intended to a common destination device/WTRU or group of associated devices/WTRUS may be referred to associated flows or correlated flows.

Within the disclosure herein, data unit may refer to one or more frames (e.g. media/video/audio frame or slice/segment), PDUs, PDU Sets, data bursts, and group of frames/PDUs/PDU-sets/data bursts. The term may also be applied to

The term quality of experience or QoE may correspond to one or both of an application and/or higher layer metrics and measurements, which may be directly or indirectly detectable/visible at the WTRU and/or application function. Such QoE metrics and measurements may or may not be directly visible/detectable at the base station, for example. Such QoE metrics and measurements may be determined/performed as a function of QoS metrics/parameters (e.g., latency, data rate, reliability, RTT/Motion to Photon (MTP) latency).

Within the discussion herein, forwarding configuration may correspond to one or more of radio bearers (e.g. data radio bearers (DRBs) and/or signaling radio bearers (SRBs), logical channels (LCHs), logical channel groups (LCGs), configuration parameters in the individual layers within the AS protocol stack (e.g. service data adaption protocol (SDAP), PDCP, RLC, MAC, physical layer (PHY), other protocol layers), parameters associated with logical channel prioritization (LCP) (e.g. priority, PBR, BSD), bandwidth parts (BWPs), carriers, radio links/interfaces (Uu links, Sidelinks (SLs)), and radio resources (e.g. set of one or more frequency/time/spatial resources such as symbols, slots, subcarriers, resource elements or beams). Radio resources may be associated with configurated grants or cell group (CG), dynamic grants (DG) and/or any other resource grants or grant free resources.

Mapping configuration may be used to correspond to one or more of the parameters and/or configurations associated with mapping. For example, a mapping configuration may be data units, PDUs, SDUs, PDU Sets, data bursts, application data (e.g. ADU) flows, and QoS flows (e.g. associated or non-associated). These parameters and/or configurations may originate from any of application layer, higher layers, and network to one or more radio bearers (e.g. DRBs, SRBs), layers, sublayers or entities (e.g. SDAP, new layer, PDCP, RLC, MAC, PHY), LCHs, carriers or component carriers (e.g. CCs in CA configurations), BWPs, and radio links/interfaces (e.g. Uu link or sidelinks). Further, these parameters and/or configurations may be used for delivering the data/PDUs in UL direction or DL direction, for example.

As used herein the terms XR/application-aware data transmissions/receptions or XR/application-aware QoS handling may correspond to one or more of the attributes associated with PDU Set, ADU or data burst: A PDU Set (e.g., media unit, video frame) may comprise of one or more PDUs. A PDU Set may be associated with PDU Set-level QoS requirements (e.g. data rate, latency, error rate, reliability), which may be applicable for one or more or all PDUs associated with the PDU Set. The different PDUs in a PDU Set may be associated with individual PDU-level QoS requirements. A data burst may refer to the data produced by the application in a short period of time, comprising PDUs from one or more PDU Sets. Such attributes, associations and inter-dependencies (e.g. intra-PDU Set and/or inter-PDU Set), including the start/end indication of a PDU Set/data burst (e.g. via sequence number, start/end indication), start/end time, duration, payload sizes, periodicity, importance/priority and QoS (e.g. PSDB) may be visible to the AS-layers (e.g. with associated IDs) and/or handled at the AS layers with the awareness of the association during data transmission in UL and reception in DL.

XR/application-aware data transmissions/receptions or XR/application-aware QoS handling may also correspond to the application or high layer importance or priority: The different PDUs in a PDU Set or all PDUs in a PDU Set may be associated with different application/high layer importance/priority values. Such importance value may correspond to spatial importance (e.g. spatial position of the video frame whose data is carried by the PDU/PDU Set, where PDUs/PDU Set carrying Field of View (FoV) spatial positions may be associated with higher spatial importance than non-FoV spatial positions) or temporal importance (e.g. time sequence of the video frame who data is carried by the PDU/PDU Set, where PDUs/PDU Sets carrying base video frames such as I-frame may be associated with higher temporal importance than differential video frames such as P-frame/B-frame). Such importance values may be visible to the Access Stratum (AS) layers (e.g., with associated IDs/markers/indications), possibly enabled by application awareness, during data transmission and reception. These terms may also correspond to QoS/data flow. The PDUs/PDU Sets of an application may be encoded and delivered by the application to the WTRU (in UL) or network (in DL) via one or more QoS/data flows. In this regard, the different QoS flows carrying the PDUs/PDU Sets associated to an XR application/experience may be visible to the AS-layers (e.g. with associated IDs) and/or handled at the AS layers with the awareness of the association during data transmission and reception.

WTRU actions, such as related to application actions and/or AS-layer actions for ensuring/supporting differentiated QoS, may correspond to one or more of determining of metadata of application, or an XR application. In example, the determination of metadata may involve determining any of the FoV/visual/spatial perimeters, 2D/3D size, border, spatial attributes and boundaries of FoV, based on measurements in any spatial dimensions, including but not limited to longitude, latitude, altitude, depth, roll, pitch, yaw in one more coordinate systems (e.g. cartesian, spherical). In a further example, the determination of metadata may involve determining the quality of the FoV content, e.g., whether the FoV content is of high quality, which in the case of an image, may be quantified and assessed by the image resolution (e.g. number of density of megapixels). As a further example, the determination of metadata may involve determining the importance and/or priority of the FoV content. The importance may be associated with the spatial importance and/or temporal importance of content/data, for example. For example, the spatial/temporal importance value may indicate the absolute or relative importance associated with the FoV content. Spatial importance may be associated with one or more segments/tiles/slices/positions of FoV in spatial dimension, for example. Temporal importance may be associated with one or more frames/subframes of FoV in time dimension, for example.

WTRU actions may also correspond to the determining/generation of application content. In examples, the determination of application content may involve determining/capturing the one or more 2D/3D images/video frames associated with an FoV boundary/perimeter/border as defined by the FoV metadata by the WTRU/node for itself and/or on behalf of another WTRU/node. For FoV content mapping, the WTRU may determine the images/video frames using visual sensors (e.g., 2D/3D camera, lidar), RF sensors (e.g., RF transceiver, RADAR), audio sensors (e.g., sonar), etc. Herein, the mapping of FoV may also be referred to as sensing of FoV content or capturing of FoV content. In another example, the determination of application content may also include recording/capturing of audio frames, either as part of the real environment or as part of an overlaid sound-track/audio file with the audio file originating from a source other than the current real environment being mapped.

WTRU actions may further correspond to performing measurements and reporting the measurement information. In an example, the WTRU may perform measurements of positioning/spatial/pose (e.g. 6DoD/3DoD orientation, location/position), rate of motion/movement, etc. of the user/WTRU and/or other objects (e.g. virtual or real) which the user may be interacting with. The WTRU may send/report the pose measurements to network, periodically or when detecting event triggers (e.g. change in pose measurements above/below a threshold). Another example may include the WTRU performing measurements of one or more of reference signals or channels (e.g. Synchronization Signal Block (SSB), channel state information (CSI) reference signal (RS), PRS, sidelink RS), GNSS signals, unlicensed carriers, ultra-wideband signals, LIDAR signals, visual signals, etc. In other examples, the WTRU may perform measurements of the radio link interfaces associated with the WTRU (e.g. Uu link, SL), the WTRU may trigger transmission and/or measurement of reference signals in other one or more WTRUS (e.g. via Uu link and/or sidelink), and/or the sending of measurement report to network and/or another WTRU.

WTRU actions may further correspond to handling/forwarding of data/PDUs/PDU Sets and the handling QoS associated with PDUs/PDU Sets. In an example, the data may include any of media/image/video frames, sensor data, and measurement data (e.g. pose measurements, link/channel measurements) determined by the WTRU, possibly for supporting an application/service/network request associated with the WTRU. In another example, the WTRU may send and/or receive data, to/from one more destinations including RAN node (e.g. gNB), CN function/entity, application function (e.g. hosted in the WTRU or in network). Still further, the WTRU may perform splitting/merging of data/PDUs in one or more QoS flows into one or more forwarding configurations during transmission/receptions.

WTRU actions may still further refer to the handling/forwarding of information related to connectivity with network and/or other WTRUs. For example, sending capability information to network may include one or more of capability for supporting one or more traffic flows with different XR traffic patterns (e.g. periodic/aperiodic, PDU Sets with variable payload sizes), capability for performing application layer measurements (e.g. QoE measurements, application buffer measurements, RTT measurements), and capability for detecting changes to traffic patterns. A further example may involve the sending of inter-WTRU coordination capability information to network, including capability for supporting one or more interfaces, capability to coordinate and/or interact with other WTRUs/devices (e.g. via SL interfaces), which may be co-located or non-co-located with the WTRU. Further examples may include one or more of receiving configuration, including receiving RRC configuration from gNB and/or NAS-layer configuration from CN; sending and/or receiving assistance data to/from network associated with traffic, QoS, scheduling, etc., for supporting UL/DL transmissions; and sending requests for radio resources and/or resource grants (e.g. dynamic grants, semi-static/configured grants).

In the various embodiments herein, there may be common components. With regard to the determination of dependencies in traffic, dependency may refer to both intra-PDU Set dependency, that is the dependency between different PDUs of a PDU Set or the inter-PDU Set dependency, that is the dependency between one or more PDU Sets. Dependency may also refer to dependency between different PDU Sets in a data burst (e.g., different PDU Sets received within a short time window).

Dependency may be determined by or known/communicated to the WTRU via the importance markings added at the application or SDAP or a new layer above/below the SDAP. For example, the importance markings may be added to the data unit (e.g., in the header of each PDU Set) or sent as metadata (e.g., via separate signaling). Further, the lower layers may be able to read the importance marking and infer any dependencies from the importance marking. Dependency may be determined by or known/communicated to the WTRU via the SN markings added at the application or SDAP or a new layer above/below the SDAP. For example, the Importance markings may be added to the data unit (e.g., in the header of each PDU Set) or sent as metadata (e.g., via separate signaling). Further, the lower layers may be able to read the importance marking and infer any dependencies from the importance marking (e.g., PDUs 1,2,3 of PDU Set 1 may be marked as [1,1], [1,2], [1,3] and PDUs 1,2 of PDU Set 2 may be marked as [2,1], [2,2].)

Dependency may further be determined by or known/communicated to the WTRU via the arrival times, for example, time keeping (e.g., at SDAP/PDCP, w.r.t. time reference (e.g., SFN), time window start/end time) and/or the lower layers may assume dependencies within two data units (e.g., two PDU Sets) that arrive within a time window of each other. Dependencies may also be determined by or known/communicated to the WTRU via the data type. For example, the subsequent frames may depend on a first one or more frames (e.g., second frame depending on first frame). Further, one frame type may be dependent on another frame type, e.g., dependent/differential frame (e.g., P-/B-frame) depending on an I-frame. A further example may be where one PDU Set Type I has higher dependencies between the constituent PDUs of the PDU Set since by definition, PDU Set Type I may not tolerate any loss/delay of any PDU in the PDU Set; as compared to PDU Set Type II-which may tolerate loss/delay of one or more PDUs in the PDU Set.

Dependency may further be determined by or known/communicated to the WTRU via the QoS flow. For example, the WTRU may determine that two PDU Sets that arrive in the same QoS flow are dependent on each other. Dependency may further be determined by or known/communicated to the WTRU via the explicit indication from higher/application layer. For example, the higher/application layer may explicitly mark two data units that are dependent on each other since the application may require both data units at the other end. For example, the application may mark PDU Set 1 and PDU Set 3 as dependent on each other (e.g., via in-band marking of PDU Set 1 and PDU Set 3 or via separate signaling indicating dependencies between PDU Set 1 and PDU Set 3) so that the lower layers in the WTRU (e.g., AS layers) may treat PDU Set 1 and PDU Set 3 in a way to maintain the dependencies. Other examples may involve the higher/application layer providing an application layer packet. The packet may be considered a PDU. The application layer packet may be an RTP packet. The packet may include a header that describes the PDU. As such, there may be a field in the header that indicates the priority (e.g., importance) of the packet relative to other packets of the same stream. The WTRU may determine that packets with the same priority value in the header are dependent on one another. There may also be a field in the header that indicates a sequence number. The WTRU may determine that PDU Sets that are associated with consecutive sequence numbers are associated with one another (e.g. a PDU Set that is associated with sequence number 4 and a PDU Set that is associated with sequence number 5 are associated). Still further, there may be a field in the header that indicates dependency. For example, dependency indication may be called a correlation ID and PDU Sets that include the correlation ID in the header may be considered dependent on one another. Alternatively, the WTRU may receive PDU Set handling rules in a NAS message. The PDU Set handling rules may be received as part of a QoS Rule. The PDU Set Handling Rules may indicate correlation ID values that should be considered to be associated with one another. For example, the PDU Set Handling Rules may indicate that Correlation ID values 5 and 3 are associated. The WTRU may then determine that any packets with a Correlation ID of 3 or 5 in the header are associated with one another.

Dependency may further be determined by or known/communicated to the WTRU via a combination of any one or more of the above. For example, the WTRU may determine that two PDU Sets of the same importance or priority that are sent consecutively (or within a short specified time window of each other) are dependent on one another. As a further example, the WTRU may determine that two PDU Sets of the same type with arrival times within a short time window of each other are dependent.

Other embodiment common components may include information on the traffic characteristics. The WTRU may send information (e.g., to the NW) or receive information (e.g., from the higher/application layers or from the NW) or determine information on the traffic characteristics: This information may include PDU Set size, number of PDUs per PDU Set, number of PDUs in data burst in one or more traffic flows. The information on traffic characteristics may include instantaneous measurements/determination and/or statistical/distribution info such as mean, min, max, standard deviation values. The information related to PDU Set may include size of the PDU Set (e.g., total payload, number of PDUs in PDU Set), indication of start/first and/or end/last PDU of PDU Set, and indication of the association/dependency of the PDUs in a PDU Set (e.g. ID of PDU Set, importance/priority value). As an example, the WTRU may receive information (e.g., from the XR application) on the number of PDUs in a PDU Set and an indication of the first PDU in the PDU Set. Based on these pieces of information, the WTRU may determine the size of the PDU Set and the last PDU of the PDU Set. As a further example, the WTRU may have received PDUs 1,2,3 from a PDU Set. Based on information on the PDU Set size (e.g., in terms of the total number of PDUs in the PDU Set), the WTRU may determine that PDUs 4,5,6 of the PDU Set are still pending and should be received soon (ideally within a time window that may allow the WTRU to transmit all the PDUs in the PDU Set within the PDU Set delay budgets (PSDB). A still further example may involve the WTRU sending to the NW or receive from the NW/application/higher layers information on PDU Sets and/or data bursts in one or more data/QoS flows, including the number of PDUs or PDU Sets (e.g., instantaneous, mean, max, min), payload size of PDU Sets and/or data burst in units of bits/bytes (e.g., instantaneous, mean, max, min), periodicity, importance/priority, start and end indication of a PDU Set and/or data burst (e.g. ID of first PDU/PDU Set, ID of last PDU/PDU Set), and dependency info within PDU Set and/or data burst and across one or more PDU Sets and/or data bursts (e.g., indicating whether one or more PDU Sets are dependent on one another and/or whether PDU Sets in one or more data bursts are dependent and/or whether PDUs within a PDU Set are dependent on one another, etc.).

Other examples of information on the traffic characteristics may include the WTRU sending information related to the jitter in UL and/or in DL. Such jitter info which may be sent on a per flow, per-PDU Set or per PDU basis, may include the range, mean, maximum and minimum value, for example. Still further the WRTU may send information on the importance/priority of any of the data units (e.g., PDUS, PDU Sets, data bursts) to be transmitted/received in UL/DL. The WTRU may also receive indications (e.g., from the NW or higher/application layer) on changes in the traffic pattern characteristics and/or may send indications when detecting changes in the UL/DL traffic patterns (e.g., changes in payload size, PDU Set sizes, data burst sizes, jitter range, periodicity etc.) Still further, the WTRU may send configuration to the NW via any one or more of RRC signaling and/or NAS messages (e.g., SRB0, SRB1, SRB2, SRB3, SRB4); control PDUs associated with any of the AS layers (e.g., SDAP control PDU, PDCP control PDU); UL MAC CE (e.g., existing MAC CE, new MAC CE, regular BSR, periodic BSR, enhanced BSR, padding BSR, pre-emptive BSR, etc.); UCI (e.g., single bit SR, multi-bit SR, feedback, ACK/NACK, CSI report); the PDCCH; the PUCCH; non-AS (NAS) layer signaling (e.g., PDU session related messages); and/or application layer signaling/messages.

Further common components on the embodiments may include the WTRU receiving configuration information from the network. The WTRU may receive from gNB, e.g., in RRC, a set of DRBs configured by the gNB (e.g., DRB1, priority of DRB1, DRB2, priority of DRB2). The WTRU may, e.g., from the gNB, receive rules/restrictions for mapping of DRB to LCH and/or mapping of DRB and/or LCH to resource grants (e.g., CG). The WTRU may receive from gNB, e.g., in RRC, a set of LCHs out of which some LCHs may be configured to handle dependencies. The LCH parameters (e.g., BSD, PBR, priority) may apply for all or some of the data units (PDUs and/or PDU Set and/or data bursts) mapped to the LCH. Further examples include the WTRU possibly receiving from gNB LCP configurations and changes in LCP configurations (e.g., LCP restrictions/rules/configurations for handling of PDUs/PDU Sets/data bursts) either for a certain time duration or indefinitely or until further notice (e.g., a change in LCP configuration). The WTRU may receive from the gNB indications on whether these LCP rules may be relaxed/changed temporarily for a time duration of whether they may be always applied. The WTRU may receive, as a further example, from the gNB configurations for multiplexing PDUs/PDU Sets/Data bursts into transport blocks. Still further examples include the WTRU potentially receiving configuration information from the NW via any one or more of RRC signaling and/or messages (e.g., dedicated/unicast signaling via any of SRBs, broadcast/SIB); control PDUs associated with any of the AS layers (e.g. SDAP control PDU, PDCP control PDU); the DL MAC CE, (iv) the downlink assignment index (DCI); the PDCCH; the PUSCH; non-AS (NAS) layer signaling (e.g., a PDU Session Establishment Response or a PDU Session Modification Command); and/or application layer signaling/messages.

In the various embodiments, one or more common components may include the information shown in FIG. 3. FIG. 3, in process 300, shows an example of the flow of two PDU Sets, with the PDU Set delay budgets (PSDB) mapped to a corresponding quality of service (QoS) flow and then to a data radio bearer (DRB). As illustrated, the PDU Set 1, with PSDB 1, is mapped to QoS Flow 1 301 and then to DRB1 302. Another PDU Set, PDU Set 2, with PSDB 2, is mapped to QoS Flow 2 303 and then to DRB2 304. The illustration shows conceptually that two different types of PDU Sets (PDU Set 1 and PDU Set 2), which differ in that they have different QoS requirements (PSDB1 and PSDB2), may be mapped to different QoS Flows and different DRBs. Further illustrated, one PDU Set 1 and one PDU Set 2 may be sent together at a time t. There may be one or more PDU Sets 1 (with PSDB 1) and one or more PDU Sets 2 (with PSDB 2) that are mapped to QoS Flow 1 301 and QoS Flow 2 303 respectively and to DRB 1 302 and DRB 2 304, respectively. These mapping and related examples may apply to one or more of the referred to herein. Further, PDU Set 1 may refer to PDU Set type 1, which may include one or more PDU Sets with PSDB 1 requirements. Type 1 here is not to be limited to the Type I PDU Set, referred to above. A PDU Set type 1 may be a Type I PDU Set or a Type II PDU Set, as described herein. PDU Set 1 may refer to one or more PDU sets with similar PDU Set level QoS requirements (e.g., the same or similar PSDB1, PSER1, PSII indication, etc.). Similarly, PDU Set 2 may refer to one or more PDU sets with similar PDU Set level QoS requirements (e.g., the same or similar PSDB2, PSER2, PSII indication, etc.). PDU Set 1 may be a PDU Set Type I or a PDU Set Type II. Similarly, for PDU Set 2, PDU Set 3, etc. they may be a PDU Set Type I or a PDU Set Type II.

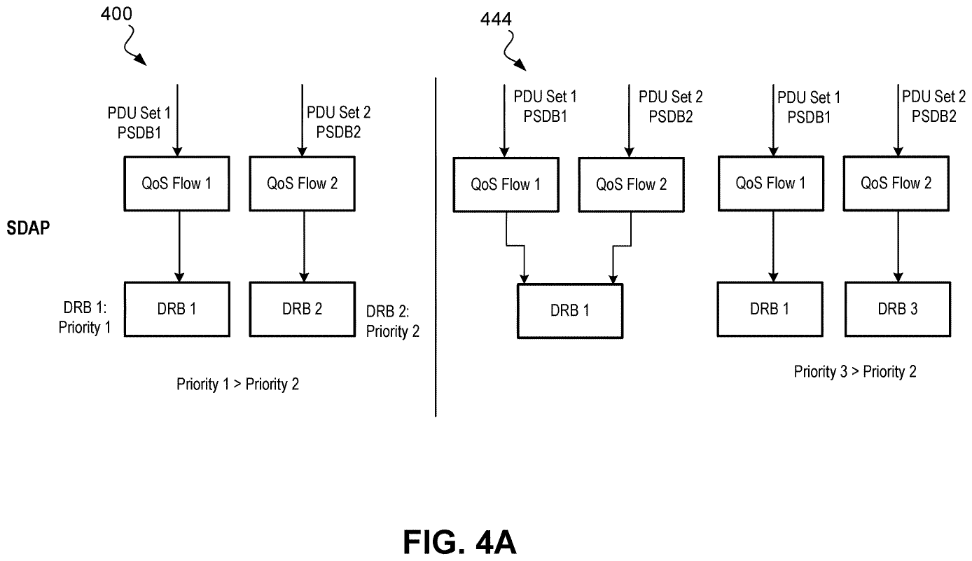

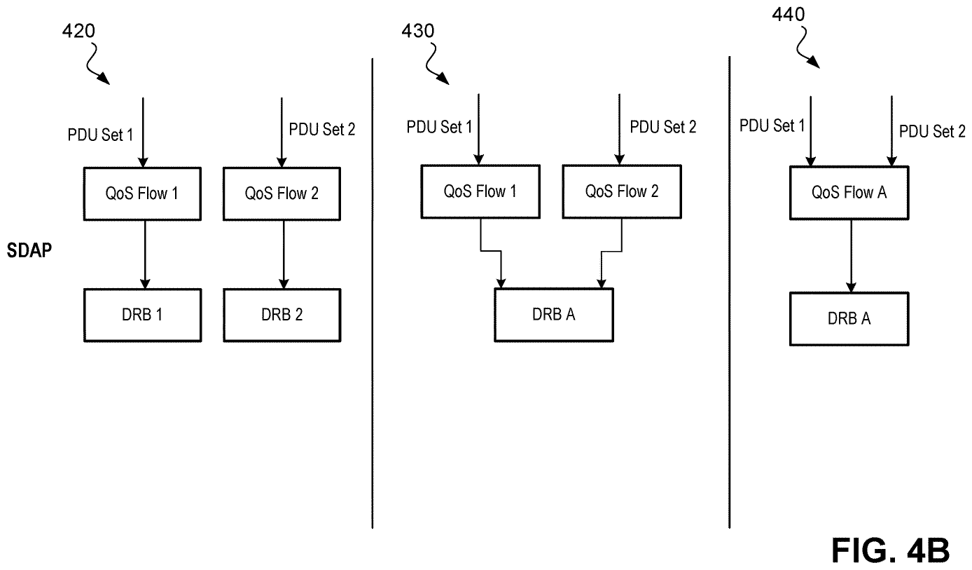

In the embodiments related to multiplexing that may involve DRB selection/dynamic change to meet QoS requirements, mechanisms may be applied at the SDAP layer (e.g., through the addition of one or more new functionality at the SDAP) or at one or more new or existing layer above or below the SDAP. FIG. 4A, in process 400, shows an example of DRB selection/dynamic change to meet QoS requirements. As shown in FIG. 4A, in process 400, PDU Set 1 (PSDB 1) and PDU Set 2 (PSDB2) may be dependent PDU Sets. PDU Set 1 (PSDB 1) may be mapped to QoS Flow 1, and then mapped to DRB 1. Similarly, PDU Set 2 (PSDB 2) may be mapped to QoS Flow 2, and then mapped to DRB 2. DRB1 may be configured for PDU Set 1 and DRB2 may be configured for PDU Set 2 (DRB config: semi-static) according to in the process shown in 420 of FIG. 4B. As shown in the process 420 shown in FIG. 4B, the WTRU (e.g., at the SDAP or another layer above the SDAP) may determine a dependency between the PDU set 1 and PDU set 2. In the process 420, the PDU Set 1 and PDU Set 2 may be mapped to respective DRB 1 and DRB 2.

Referring again to the process 400 shown in FIG. 4A, DRB1 may have a priority of Priority 1 and DRB 2 may have a priority of Priority 2. Priority 1 may be higher than Priority 2. Based on priorities, PDU Set 1 may be mapped to DRB 1 and PDU Set 2 may be mapped to DRB 2 to ensure PSDB 1 and PSDB 2 are met, and to ensure dependencies of PDU Set 1 and PDU Set 2 are maintained using the process 420 shown in FIG. 4B. As shown in FIG. 4A, at 444, PDU Set 2 may arrive late (e.g., due to jitter) such that PSDB2 is approaching. PSDB 2 and dependencies of PDU Set 1 and PDU Set 2 may no longer be met/maintained using DRB2. DRB 2 may be given lower priority than DRB 1 and DRB 3. PDU Set 2 may be mapped to DRB 3, which is the next highest priority because PDU Set 1 and PDU Set 2 are dependent. The WTRU may determine to change priority of PDU Set 2 to maintain PSDB2 and dependencies by mapping PDU Set 2 through QoS Flow 2 to DRB 1 or mapping PDU Set 2 through QoS Flow 2 to another preconfigured DRB 3. In this change of priority that PDU Set 2 is mapped to DRB 3, priority 3 has a higher priority than priority 2.

The WTRU may receive from the NW or a network entity, e.g., in RRC or other configuration message, a set of DRBs configured by the gNB (e.g., a first set of DRBs (DRB1), priority of DRB1, a second set of DRBs (DRB2), priority of DRB2). The WTRU may receive a first set of protocol data units, PDU Set 1, e.g., from an XR application. The WTRU maps/forwards PDU Set 1 to DRB1 based on importance or priority of PDU Set 1. The WTRU may receive PDU Set 2, e.g., from the XR application (e.g., PDU Set 2 may arrive later than expected). The WTRU may determine information on dependency regarding the first set of PDUs and the second set of PDUs based on information associated with the first set of PDUs and the second set of PDUs e.g., arrival times, data type, etc. Thus, the information on dependency may include arrival times or data type In the example, the WTRU may determine PDU Set 1 and PDU Set 2 are dependent. The WTRU may then determine success rate of PDU. The WTRU may determine the new QoS/priority of PDU Set 2 based on QoS requirements like/based on performance/success rate of first PDU Set and the dependency regarding the first set of PDUs and the second set of PDUs. Based on the priority of the first set of PDUs and the priority of the second set of PDUs, the WTRU may determine to change priority of PDU Set 2 to ensure QoS and dependencies by mapping of PDU Set 2 to DRB 1 or mapping of PDU Set 2 to another preconfigured DRB, e.g., DRB 3 where priority of DRB 3>priority of DRB 2).

FIG. 4B represents the mapping between PDU Sets, QoS Flows and DRBs (e.g., at the SDAP layer) for process 420, process 430 and process 440. WTRU (e.g., SDAP OR new layer above SDAP) may determine dependency between PDU Set 1 and PDU Set 2. The process 420 is described herein. In the process 430, f PDU Set 1 and PDU Set 2 may arrive in different QoS flows, WTRU may map them to the same DRB according to process 430 to ensure that newly derived dependencies are maintained. As shown in the process 440, PDU Set 1 and PDU Set 2 may each arrive in the same QoS Flow A, and the WTRU may map them to the same DRB A.

In embodiments, a determination may be performed relative to the performance/success rate of one data unit based on feedback mechanism/delay. The WTRU may determine the performance/success rate of PDU Set 1 based on feedback and/or remaining delay. For example, the WTRU may receive feedback from a network entity like gNB on a previously transmitted PDU Set 1. An example of feedback may be the number of hybrid automatic repeat request (HARQ)/automatic repeat request (ARQ) (re)transmissions or any other feedback (e.g., in PDCP status report, PDCP control PDU, SDAP control PDU) from the gNB to determine the success rate. In a further example, the feedback may include information like an acknowledgement (ACK) on the number of PDUs of a PDU Set received successfully and/or a negative ACK (NACK) of the number of PDUs to be retransmitted by the WTRU. In another example, the WTRU may send information on whether PDU Set 1 transmitted in the UL may be followed by ACK/NACK feedback indications which the WTRU may expect to receive from the gNB and/or the higher layers (e.g., TCP, RTP) and/or lower layers (e.g., HARQ, ARQ) within a preconfigured time window after sending a PDU Set 1 in the UL. In a further example that may be linked to a similar embodiment in the DL implemented by the NW, the WTRU may send information to the NW, for example, to allow the NW to determine the performance/success rate of PDU Set 1. The WTRU may send information on whether the data units received in the DL may be followed by ACK/NACK feedback indications which the WTRU may expect to transmit to the gNB and/or the higher layers (e.g., TCP, RTP) and/or lower layers (e.g., HARQ, ARQ) within a preconfigured time window after receiving a PDU Set 1 in the DL.

In further examples of the determination performed relative to the performance/success rate of one data unit based on feedback and/or remaining delay, the WTRU may measure the time delay, elapsed time or remaining delay, e.g., absolute time data unit has spent in buffer or time spent in buffer with respect to (w.r.t.) the delay budget of a set of PDUs or the data unit (e.g., w.r.t. the PSDB for a PDU Set or the PDB for a PDU or a set of PDUs). In this example, the PDU Set that has spent the shortest time in the buffer may score or may result in the higher success rate. Further, the WTRU may determine the performance/success rate of a PDU Set as a measure of the percentage of the PDUs of a PDU Set transmitted successfully (e.g., above a percentage threshold). Alternatively, the WTRU may determine the performance/success rate of a PDU Set as a measure of the time elapsed for transmitting certain PDUs of the PDU Set (e.g., below a delay threshold). In another example, the WTRU may determine the performance/success rate of a PDU Set as a function of both the percentage of PDUs transmitted and the time elapsed for transmission of the PDUs. For example, the success rate of a PDU Set at a measurement occasion (e.g., time instance T) may be determined as the ratio of 1) the percentage of the PDUs of a PDU Set transmitted successfully up to the time instance T and 2) the percentage of the time elapsed with respect to the PSDB for successfully transmitting the PDUs up to the time instance T.

In embodiments, the determination of the performance/success rate of a set of PDUs may be statistical vs/or instantaneous. For example, the WTRU may keep track of the performance/success rate of a PDU Set based on its performance over a past time window and take these statistics into account when determining to switch the mapping of another PDU Set to the DRB of that PDU Set. As a further example, the WTRU may do spot checks on the performance/success rate of a PDU Set instantaneously.

In embodiments, for the performance/success rate of a set of PDUs may be event-triggered. For example, the WTRU may receive a request from the gNB to measure the performance/success rate of a PDU Set. As another example, upon registering a relatively lower score or a score below a defined threshold or a high score above a defined threshold for a performance/success rate, the WTRU may do another check on that PDU Set. Still further, upon reception of several consecutive NACK indications from the gNB, the WTRU may decide to measure the performance/success rate of a PDU Set.

The WTRU may also receive thresholds corresponding to performance/success rates above or below a threshold from the gNB. The performance/success rates above the threshold may be relatively better than the performance/success rates below the threshold. The WTRU may assess the performance of the PDU Sets against those thresholds when determining whether to change mapping or not.

In embodiments, a determination may be made relative to new QoS/priority of data unit based on performance/success rate of another data unit and/or dependencies between two data units. In one example, one data unit (e.g., PDU Set 2) may arrive late at the WTRU (e.g., due to jitter) such that its delay budget (e.g., PSDB 2) is almost approaching. The WTRU may also determine that mapping PDU Set 2 to DRB 2 may not ensure that PSDB 2 is met, and some expediting may be needed. The WTRU may further determine the new QoS/priority of one PDU Set (e.g., PDU Set 2) based on performance/success rate of PDU Set 1. For example, if PDU Set 1 performs well, the WTRU may switch the mapping of PDU Set 2 from DRB 2 to DRB 1. Also, for example, if PDU Set 1 does not perform well, the WTRU may switch the mapping of PDU Set 2 from DRB 2 to another DRB 3 (where the priority of DRB 3>the priority of DRB 2. Still further, if the WTRU has determined that there may be dependencies between PDU Set 1 and PDU Set 2, such that PDU Set 1 cannot be reconstructed without PDU Set 2, and PDU Set 1 has a good performance/success rate (above a threshold configured by gNB), the WTRU may switch the mapping of PDU Set 2 from DRB 2 to DRB 1.

In embodiments, a selection/change of DRBs may be based on dependencies. The WTRU may initially map/forward PDU Set 1 to DRB1 based on importance of PDU Set 1. The WTRU may also determine to change priority of PDU Set 2 to ensure QoS and dependencies by mapping of PDU Set 2 to DRB 1 or mapping of PDU Set 2 to another preconfigured DRB 3 (priority 3>priority 2).

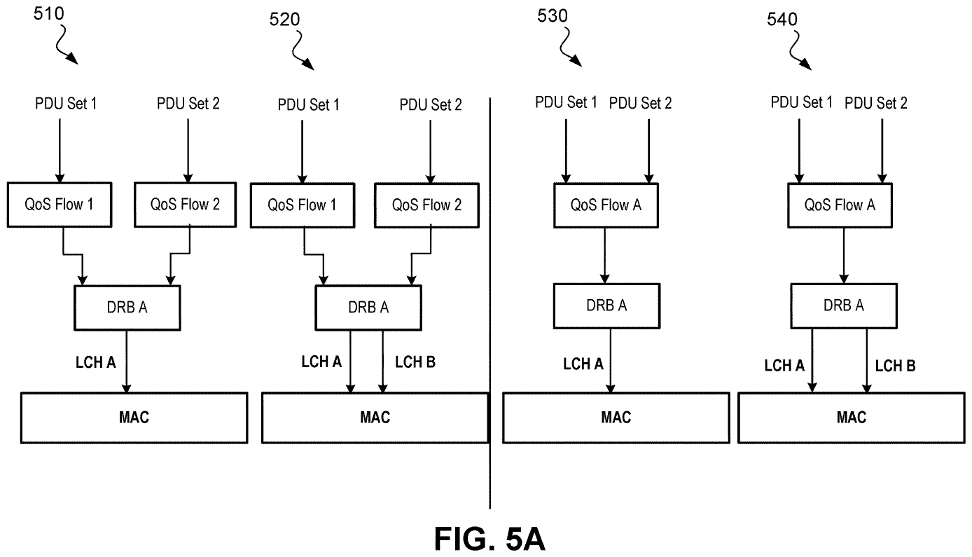

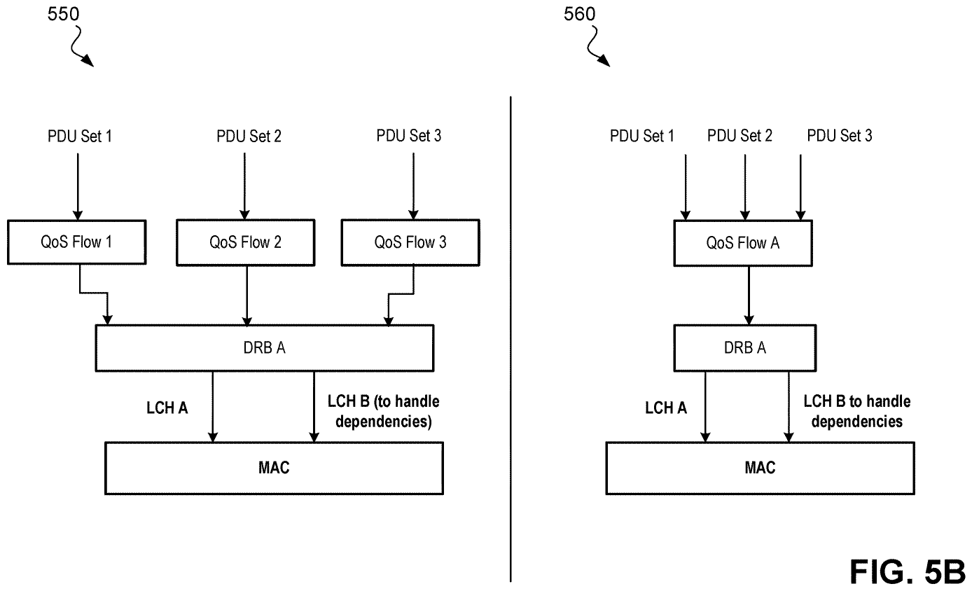

In embodiments for multiplexing, the configuration may involve the LCH being restricted to handle dependencies, which may be considered a NW assisted embodiment. Example illustrations of this embodiment are shown in FIGS. 5A and 5B. FIG. 5A represents options for mapping the PDU Sets in DRBs to one or more LCHs according to processes 510 and 520 and processes 530 and 540. Processes 510 and 520 may be one option for mapping the PDU sets in DRBs to LCHs. The process 510 illustrates an example of 1 -to-1 mapping (PDCP maps PDU sets to one LCH). PDU Set 1 and PDU Set 2 may arrive in different QoS Flows (QoS Flow 1 and QoS Flow 2). The WTRU, may map the PDU Set 1 and PDU Set 2 to the same DRB, DRB A. The PDCP may map PDU Set 1 and PDU Set 2 to one logical channel, LCH A. The MAC may multiplex the PDU sets received via the logical channel, LCH A.

The process 520 illustrates an example of 1-to-M mapping of PDU sets to LCHs (e.g., PDCP may map PDU sets to more than one LCHs). PDU Set 1 and PDU Set 2 may arrive in different QoS Flows (QoS Flow 1 and QoS Flow 2). The WTRU may map the PDU Set 1 and PDU Set 2 to the same DRB, DRB A. The PDCP may map PDU Set 1 and PDU Set 2 to different logical channels, LCH A and LCH B. The MAC may multiplex the PDU sets received via the logical channels, LCH A and LCH B.

Processes 530 and 540 is another option for mapping the PDU sets in DRBs to LCHs. The process 530 illustrates an example of a 1-to-1 mapping of PDU sets to one LCH(PDCP maps PDU sets to one LCH). PDU Set 1 and PDU Set 2 may arrive in the same QoS Flow (QoS Flow A). The WTRU may map the PDU Set 1 and the PDU Set 2 to the same DRB, DRB A. The PDCP may map PDU Set 1 and PDU Set 2 to one logical channel, LCH A.

The process 540 illustrates an example of 1-to-M mapping of PDU sets to more than one (PDCP maps PDU sets to more than one LCHs). PDU Set 1 and PDU Set 2 arrive in the same QoS Flow (QoS Flow A). The WTRU may map the PDU Set 1 and the PDU Set 2 to the same DRB, DRB A. The PDCP may map PDU Set 1 and PDU Set 2 to different logical channels, LCH A and LCH B.

In FIG. 5B, in the processes of 550 and 560, WTRU may determine that there are dependencies between PDU Set 1 and PDU Set 3. At process 550, PDU Set 1 may be mapped to QoS Flow 1, PDU Set 2 may be mapped to QoS Flow 2, and PDU Set 3 may be mapped to QoS Flow 3. If parameters of LCH B (e.g., priority, PBR) meet the QoS requirements for dependent PDU Sets (PSDB1, PSDB3), the WTRU may map dependent PDU Sets (PDU Set 1 and PDU Set 3) to LCH B. In case of conflict between independent LCH and restricted dependent LCH during LCP procedure, WTRU may be configured to prioritize restricted dependent LCH. At process 560, PDU Set 1, PDU Set 2, and PDU Set 3 may be mapped to QoS Flow A. If parameters of LCH B (e.g., priority, PBR) meet the QoS requirements for dependent PDU Sets (PSDB1, PSDB3), the WTRU may map dependent PDU Sets (PDU Set 1 and PDU Set 3) to LCH B. In case of conflict between independent LCH and restricted dependent LCH during LCP procedure, WTRU may be configured to prioritize restricted dependent LCH. For example, LCH B may be reserved to handle dependencies. The WTRU may receive from NW or a network entity, e.g., in RRC, a set of LCHs, a first one or more LCHs and a second one or more LCHs, configured by the gNB, the second one or more LCHs including one or more LCH that are restricted to handle dependency (e.g., LCH B) between PDUs. The WTRU may receive one or more PDU Sets, e.g., from an XR application. The WTRU may determine information on dependency requirements for PDU sets based on information associated with PDU sets, e.g., arrival times, data type. (e.g., the WTRU may determine PDU Set 1 and PDU Set 3 are dependent). Thus, the dependency requirements may be based on arrival times or a data type. If parameters of LCH B (e.g., priority associated with the first LCHs and the second LCHs, prioritized bit rate (PBR)) meet the requirements for dependent PDU Sets (e.g., PSDB1, PSDB3), WTRU may map dependent PDU Sets to LCH B.

In case of conflict between independent LCH and restricted dependent LCH during LCP procedure, the WTRU may be configure to prioritize restricted dependent LCH, and may map dependent PDU Sets to LCH B. (For less impact to PSER). For example, if priority of LCH A (non-dependent LCH) is the same as or equals to priority of LCH B (special LCH handling dependencies), the WTRU may be configured to prioritize LCH B.

In embodiments, the WTRU may receive configuration info from the network, including LCH to handle dependencies. In one example, the WTRU may receive from the NW, e.g., in RRC and/or following a request sent from the WTRU to the NW, a set of LCHs configured by the gNB, including one or more LCH(s) to handle dependencies. For UL traffic (generated in the WTRU application), the WTRU may have some knowledge of the (expected) traffic pattern, e.g., for an upcoming time window. The WTRU may send indications to the network on its traffic pattern in advance and the network may be able to configure the LCHs accordingly. For example, the WTRU may know the periodicity of an upcoming video traffic. The WTRU may send this information to the gNB. The gNB may then configure the LCHs accordingly. In a related example, the WTRU may receive information about dependencies in its UL traffic and/or upcoming UL traffic (e.g., from the application) or determine information on dependencies in its UL traffic and/or upcoming UL traffic and send this information to the gNB. The gNB may then configure one or more logical channels that may be restricted to handle such dependencies. Further, an LCH may be set to handle dependencies. The set LCH may have similar parameters to a regular LCH (e.g., PBR, BSD, priority). The set LCH may also have additional parameters related to dependencies. For example, LCH B may be restricted to only map with I-frames and their differential P-/B-frames. The set LCH may be restricted to handle dependencies. For example, the LCH (e.g., LCH B) restricted to handle dependencies is only used to carry dependent PDU Sets. For example, if PDU Set 1 and PDU Set 3 are dependent, they may be mapped to LCH B. As a further example, if there are no dependent PDU Sets at a given time, a standalone PDU Set (e.g., PDU Set 2 which is not dependent on any other PDU Set and does not have another PDU Set depending on it) may not be mapped to LCH B even if LCH B may be available at that time (e.g., not loaded with dependent PDU Sets). Further, the set LCH may handle dependencies as a priority but may be able to also map to standalone data units in the absence of dependent data units. For example, if there are no dependent PDU Sets at a given time, a standalone PDU Set (e.g., PDU Set 2 which is not dependent on any other PDU Set and does not have another PDU Set depending on it) may be mapped to LCH B which, in the presence of other dependent PDU Sets (e.g., PDU Set 1 and PDU Set 3) would be used to handle the dependent PDU Sets.

A further example of receiving configuration information from the network, with knowledge of a large volume of UL traffic coming, the gNB may configure a higher number of LCHs and/or the LCH parameters of respective logical channels (e.g., prioritized bitrate, PBR) to accommodate a larger volume of data per LCH (e.g., higher PBR), and LCHs to handle dependencies. The gNB may configure the LCH to handle dependencies as restricted to only handle dependent PDU Sets or as configured to prioritize dependent PDU Sets.

Where one or more LCH may be configured by the gNB to prioritize dependent PDU Sets, the configuration information may let the WTRU decide whether to only use the LCH to map to dependent PDU Sets (e.g., restrict its usage to only handle dependencies) or to also use the LCH to map to standalone PDU Sets in the absence of dependent PDU Sets.

In another example, the gNB may configure one or more LCHs (e.g., LCH D) to also handle intra-PDU Set dependencies, e.g., dependencies between different PDUs in one PDU Set, such that each of the PDUs of one PDU Set may be mapped to LCH D. In one example, LCH D may be restricted to only map to Type I PDU Set since the dependency requirement is stronger for Type I (e.g., Type I PDU Set cannot tolerate any loss/delay of any PDU in the PDU Set while Type II PDU Set can tolerate some loss/delay and still be reconstructed at the end).

Another example of receiving configuration information from the network, the gNB may send to the WTRU a range of allowable changes to the LCH parameters that the WTRU may be able to make. For example, within a DRB, the gNB may configure a range of values for the PBR of each logical channel that maps to that DRB. The WTRU may be able to adjust/control the LCH parameter (e.g., PBR) based on the dependency information that the WTRU has determined/received (e.g., from higher/application layer). For example, the WTRU may be able to decide whether to use an LCH to handle dependencies strictly to map to dependent PDU Sets or to prioritize dependent PDU Sets (and also map to standalone PDU Sets in the absence of dependent PDU Sets).

In embodiments, the data units may be mapped to the LCH configured to handle dependencies. There may be one or more LCHs configured by the gNB and sent to the WTRU to handle dependencies (e.g., LCH B sent in RRC). In one example, the WTRU has received information (e.g., from higher/application layer) or has determined that there are dependencies between PDU Set 1 and PDU Set 3, and has received from the gNB LCH B configured to handle dependencies. For example, if the parameters of LCH B (e.g., PBR, BSD, priority) meet the requirements for the dependent PDU Sets, e.g., PSDB 1 of PDU Set 1 and PSDB 3 of PDU Set 3, the WTRU may map PDU Set 1 and PDU Set 3 to LCH B. Further, if the parameters of LCH B (e.g., PBR, BSD, priority) do not meet the requirements for each the dependent PDU Sets or do not meet the dependency requirements for the PDU sets, e.g., the parameters of LCH B may be suitable for PDU Set 3 but not for PDU Set 1, the WTRU may receive configuration information for another LCH C from the network entity. The WTRU may further map PDU Set 1 and PDU Set 3 to LCH C that may have been configured and sent to the WTRU (e.g., in RRC) with parameters suitable for the requirements of both PDU Set 1 and PDU Set 3, and thus meet the dependency requirements for PDU sets. If the parameters of LCH B (e.g., PBR, BSD, priority) do not meet the requirements for each the dependent PDU Sets or do not meet the dependency requirements for the PDU sets, e.g., the parameters of LCH B may be suitable for PDU Set 3 but not for PDU Set 1, the WTRU may send an indication to the network entity (e.g., gNB) to request for another LCH to handle dependencies with parameters suitable for the requirements of both PDU Set 1 and PDU Set 3, where the requested another LCH meets the dependency requirements for the PDU sets, and on reception of the new LCH map it to PDU Set 1 and PDU Set 3. If the parameters of LCH B (e.g., PBR, BSD, priority) do not meet the requirements for each the dependent PDU Sets or do not meet the dependency requirements for the PDU sets, e.g., the parameters of LCH B may be suitable for PDU Set 3 but not for PDU Set 1, the WTRU may determine to use a regular LCH, such as the one or more LCH for the PDU Set 1 (not configured to handle dependencies) to map PDU Set 1 to make sure that PSDB 1 is met if the requested another LCH is not received. The WTRU may choose this option if, for example, it has not received any LCH to handle dependencies that meet the requirements of each of the dependent PDU Sets, either in RRC or in response to a request sent to the gNB to ask for one.

In embodiments, the configuration may include information on how to handle the conflict between two different types of LCH. During the LCP procedure, the WTRU may be configured to prioritize PDUs in one or more LCHs based on the regular LCH parameters (e.g., priority, PBR, BSD). In one example, if LCH A (regular LCH) has higher priority than LCH B (LCH configured to handle dependencies), the WTRU may prioritize the PDUs/PDU Sets mapped to LCH A to put into transport blocks over the PDUs/PDU Sets mapped to LCH B. In another example, there may be a conflict between a regular LCH (e.g., LCH A) configured by the gNB and a LCH configured to handle dependencies (LCH B). For example, both LCHs may have similar parameters (e.g., priority, PBR, BSD). In this example, the WTRU may be configured to prioritize LCH B over LCH A, e.g., take the PDUs/PDU Sets mapped to LCH B to add to the first transport block over the PDUs/PDU Sets mapped to LCH A. This is because any loss/delay for data units mapped to LCH B will have a higher impact to the PDU Set Error Rate (PSER) compared to any loss/delay for data units mapped to LCH A. Further options for this example may include Standalone PDU Set 2 is mapped to LCH A. Dependent PDU Set 1 and PDU Set 3 are mapped to LCH B. Loss/delay of any PDUs in PDU Set 2 may only impact reconstruction of PDU Set 2 while loss/delay of any PDUs in either PDU Set 1 or PDU Set 3 may impact reconstruction of both PDU Set 1 and PDU Set 3, having a bigger impact to the PSER.

In embodiments, the configuration may include information dynamic change of LCH parameters (e.g., PBR, BSD, priority). Within a DRB, a WTRU may dynamically change/control some parameters, e.g., LCH parameters, e.g., adjust PBR of a logical channel based on dependencies. In one example, the WTRU may inform the gNB of a large volume of UL traffic coming. In response, the gNB may configure a higher number of LCHs and/or the LCH parameters of respective logical channels (e.g., prioritized bitrate, PBR) to accommodate a larger volume of data per LCH (e.g., LCH with a higher PBR) and send this configuration information to the WTRU (e.g., in RRC). In another example, the WTRU may receive from the network entity like gNB a range of allowable changes to the LCH parameters or configuration information that the WTRU may be able to make on its own. For example, within a DRB, the WTRU may be configured with a range of values for the PBR of each logical channel that maps to that DRB. The WTRU may be able to adjust/control the LCH parameter (e.g., PBR) based on the latest information on the UL traffic received or determined by the WTRU. Related to the forgoing example, the WTRU may adjust the configuration information or the LCH parameter (e.g., PBR) to accommodate the dependencies between two data units or two sets of PDUs. For example, the WTRU may increase/raise the PBR of a logical channel carrying PDU Set 1 to also fit in PDUs of PDU Set 3 if it knows that there are dependencies between PDU Set 1 and PDU Set 3.

An exemplary embodiment for multiplexing may involve DBR selection/dynamic change to meet QoS requirements. The WTRU may receive from the NW, e.g., in the RRC, a set of DRBs configured by the gNB (e.g., DRB1, priority of DRB1, DRB2, priority of DRB2). The WTRU may receive PDU Set 1, e.g., from XR application. Further, the WTRU maps/forwards PDU Set 1 to DRB1 based on importance of PDU Set 1. The WTRU may receive PDU Set 2, e.g., from XR application (e.g., PDU Set 2 may arrive later than expected). The WTRU determines information on dependency based on, e.g., arrival times, data type (e.g., the WTRU determines PDU Set 1 and PDU Set 2 are dependent), etc. The WTRU may further determine success rate of PDU Set 1 based on feedback and/or remaining delay. (statistics vs instantaneous). The WTRU also determines the QoS/priority of PDU Set 2 based on performance/success rate of first PDU Set. The WTRU may determine to change priority of PDU Set 2 to ensure QoS and dependencies by (i) mapping of PDU Set 2 to DRB 1 or (ii) mapping of PDU Set 2 to another preconfigured DRB 3 (priority 3>priority 2).

Another exemplary embodiment for multiplexing may involve configuration of the LCH to be restricted to handle dependencies, which may be considered a network assisted embodiment. The WTRU may receive from the NW, e.g., in RRC, a set of LCHs configured by the gNB, including one or more LCH that are restricted to handle dependency (e.g., LCH B). The WTRU then receives one or more PDU Sets, e.g., from XR application. The WTRU determines information on dependency based on e.g., arrival times, data type. (e.g., the WTRU determines PDU Set 1 and PDU Set 3 are dependent). If parameters of LCH B (e.g., priority, PBR) meet the requirements for dependent PDU Sets (PDU Set delay budgets (PSDB), e.g., PSDB1, PSDB3), the WTRU may maps dependent PDU Sets to LCH B. In case of conflict between independent LCH and restricted dependent LCH during LCP procedure, the WTRU may be configured to prioritize restricted dependent LCH, which may result in a reduction of the impact to the PSER. As an example, if priority of LCH A (legacy LCH) is the same as priority of LCH B (special LCH handling dependencies), the WTRU may be configured to prioritize LCH B.

The terms and concepts disclosed herein may include terms and concepts not disclosed or described in those standard documents, and thus the concepts and terms herein are not meant to be solely limited to how such terms are used in the existing standards. Rather, these standards are referenced to the extent necessary in order to provide background reference for understanding.

The processes and instrumentalities described herein may apply in any combination, may apply to other wireless technologies, and for other services. A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A wireless transmit/receive unit (WTRU) comprising:
a processor configured to:
receive, from a network (NW) entity, configuration information for a first one or more logical channels (LCHs) and a second one or more LCHs, the second one or more LCHs including one or more LCHs that are restricted to handle dependency between protocol data units (PDUs);
receive, from an extended reality (XR) application, a first set of PDUs and a second set of PDUs;
determine dependency requirements for the first set of PDUs and the second set of PDUs based on at least one of arrival times or a data type;
determine a first priority associated with the first one or more LCHs and a second priority associated with the second one or more LCHs; and
in response to the second priority of the second one or more LCHs meeting the dependency requirements for the first set of PDUs and the second set of PDUs, map the first set of PDUs and the second set of PDUs to the second one or more LCHs.

2. The WTRU of claim 1, wherein the processor is further configured to:
in response to a conflict between the priority of the first one or more LCHs and the second one or more LCHs, map the first set of PDUs and the second set of PDUs to the second one or more LCHs.

3. (canceled)

4. The WTRU of claim 2, wherein the processor is further configured to:
determine to prioritize the second one or more LCHs over the first one or more LCHs based on upon determining that the first priority of the first one or more LCHs equals to the second priority of the second one or more LCHs.

5. The WTRU of claim 1, wherein the processor is further configured to:
receive, from the network entity, configuration information for a third one or more LCHs. in response to the second priority of the second one or more LCHs does not meet the dependency requirements for the first set of PDUs and the second set of PDUs, map the first set of PDUs and the second set of PDUs to the third one or more LCHs, wherein a third priority of the third one or more LCHs meets the dependency requirement for the first set of PDUs and the second set of PDUs.

6. The WTRU of claim 1, wherein the processor is further configured to:
in response to the second priority of the second one or more LCHs does not meet the dependency requirements for the first set of PDUs and the second set of PDUs, send, to the network entity, an indication to request for a third one or more LCHs, wherein a third priority of the third one or more LCHs meets the dependency requirement for the first set of PDUs and the second set of PDUs.

7. The WTRU of claim 6, wherein the processor is further configured to:
in response to determining that the third one or more LCHs are not received, map the first set of PDUs to the first one or more LCHs.

8. The WTRU of claim 1, wherein the processor is further configured to:
receive, from the network entity, a range of allowable changes to the configuration information; and
adjust the configuration information to accommodate the dependency between the first set of PDUs and the second set of PDUs.

9. A method implemented by a wireless transmit/receive unit (WTRU), the method comprising:
receiving, from a network (NW) entity, configuration information for a first one or more logical channels (LCHs) and a second one or more LCHs, the second one or more LCHs including one or more LCHs that are restricted to handle dependency between protocol data units (PDUs);
receiving, from an extended reality (XR) application, a first set of PDUs and a second set of PDUs;
determining dependency requirements for the first set of PDUs and the second set of PDUs based on at least one of arrival times or a data type;
determining a first priority associated with the first one or more LCHs and a second priority associated with the second one or more LCHs; and
in response to the second priority of the second one or more LCHs meeting the dependency requirements for the first set of PDUs and the second set of PDUs, mapping the first set of PDUs and the second set of PDUs to the second one or more LCHs.

10. The method of claim 9, further comprising:
in response to a conflict between the priority of the first one or more LCHs and the second one or more LCHs, mapping the first set of PDUs and the second set of PDUs to the second one or more LCHs.

11. (canceled)

12. The method of claim 10, further comprising:
determining to prioritize the second one or more LCHs over the first one or more LCHs based on upon determining that the first priority of the first one or more LCHs equals to the second priority of the second one or more LCHs.

13. The method of claim 9, further comprising:
receiving, from the network entity, configuration information for a third one or more LCHs.
in response to the second priority of the second one or more LCHs does not meet the dependency requirements for the first set of PDUs and the second set of PDUs, mapping the first set of PDUs and the second set of PDUs to the third one or more LCHs, wherein a third priority of the third one or more LCHs meets the dependency requirement for the first set of PDUs and the second set of PDUs.

14. The method of claim 9, further comprising:
in response to the second priority of the second one or more LCHs does not meet the dependency requirements for the first set of PDUs and the second set of PDUs, sending, to the network entity, an indication to request for a third one or more LCHs, wherein a third priority of the third one or more LCHs meets the dependency requirement for the first set of PDUs and the second set of PDUs.

15. The method of claim 14, further comprising:
in response to determining that the third one or more LCHs are not received, mapping the first set of PDUs to the first one or more LCHs.

16. The method of claim 9, further comprising:
receiving, from the network entity, a range of allowable changes to the configuration information; and
adjusting the configuration information to accommodate the dependency between the first set of PDUs and the second set of PDUs.
